(19) United States
(12) Patent Application Publication
(10) Pub. No.: US 2014/0285346 A1
(43) Pub. Date: Sep. 25, 2014

(54) POWER SUPPLY DETECTING CIRCUIT FOR VENDING MACHINE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: YI-LIANG LI, Wuhan (CN); LI-PING FAN, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/064,546

(22) Filed: Oct. 28, 2013

(30) Foreign Application Priority Data
Mar. 20, 2013 (CN) 2013100888259

(51) Int. Cl. G08B 3/10

(52) U.S. Cl. CPC G08B 3/10
USPC 340/635

(57) ABSTRACT

A power supply detecting circuit for detecting a power supply status of a controlling system of a vending machine, includes a port equipped on the controlling system, a power supply unit, an alarming unit, and a switch unit. The port outputs a high level voltage signal when a normal power is supplied to the controlling system. The power supply unit provides power to the alarming unit. The switch unit is connected between the alarming unit and ground. The switch unit is controlled by the port. The switch unit is turned off to switch off the alarming unit when the high level voltage signal is outputted from the port. The switch unit is turned on to switch on the alarming unit when the normal power is not supplied to controlling system and the high level voltage signal is not outputted from the port.

### BACKGROUND

1. Technical Field

The present disclosure relates to detecting circuits, and particularly to a power supply detecting circuit for a vending machine.

2. Description of Related Art

Most vending machine are equipped with a control system. The control system controls collection of money, delivering of goods, and communication with outside, for example. However, if one item of good is dropped in the vending machine, the vending machine is impacted which may influence a power supply to the control system. Thus, the vending machine can not work normally.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a power supply detecting circuit for a vending machine.

FIG. 2 is a circuit diagram of a power supply unit of the power supply detecting circuit of FIG. 1.

FIG. 3 is a circuit diagram of an alarming unit and a switch unit of the power supply detecting circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

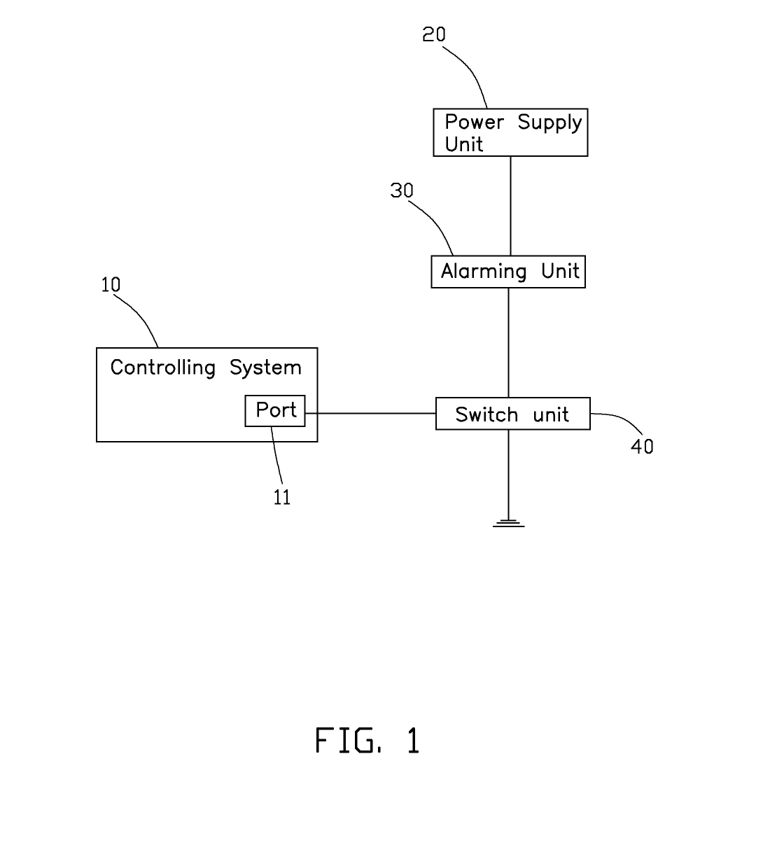

FIG. 1 shows an embodiment of a power supply detecting circuit for detecting a power supply status of a controlling system 10 of a vending machine. The power supply detecting circuit includes a power supply unit 20, an alarming unit 30, and a switch unit 40. The controlling system 10 includes a port 11. When there is a normal power provided to the controlling system 10, the port 11 outputs a high-level voltage signal. When there is not a normal power provided to the controlling system 10, the port 11 does not output the high-level voltage signal. In one embodiment, the port 11 is a USB port.

The power supply unit 20 is connected to the alarming unit 30 to provide power to the alarming unit 30. The alarming unit 30 is connected to ground via the switch unit 40. When the switch unit 40 is on, the alarming unit 30 is turned on to sound an alarm.

The port 11 is connected to the switch unit 40 to turn on or off the switch unit 40.

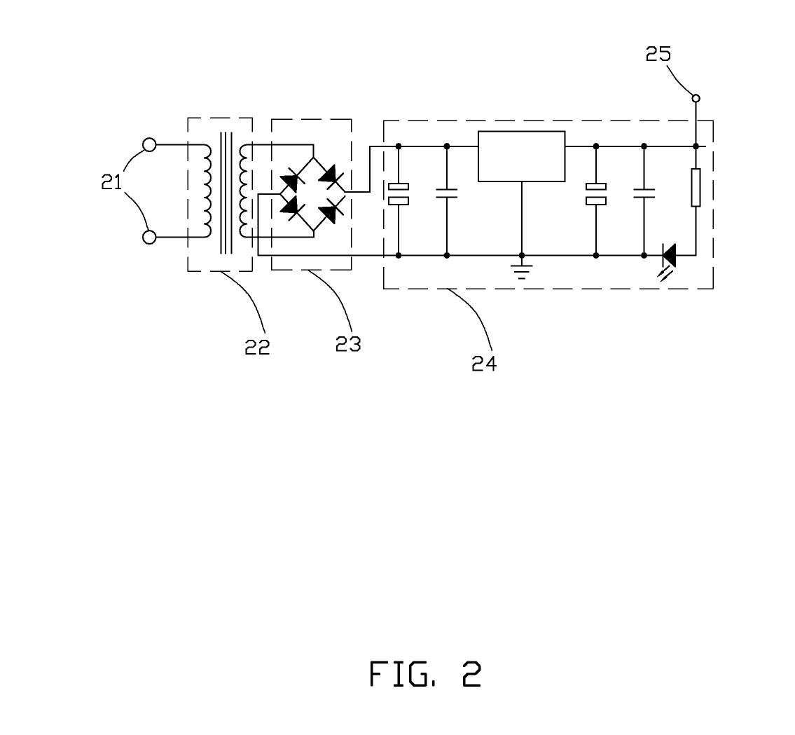

FIG. 2 shows a circuit diagram of the power supply unit 20. The power supply unit 20 includes input ends 21, an iron core transformer 22, a bridge circuit 23, a converting and filtering circuit 24, and an output end 25. The input ends 21 are connected to a utility power, such as 110V AC power. The iron core transformer 22 transforms the utility power into a 24V AC power. The 24V AC power is converted into a 16V DC power by the bridge circuit 23. The converting and filtering circuit 24 converts the 16V DC power in to a 12V DC power, which is outputted from the output end 25.

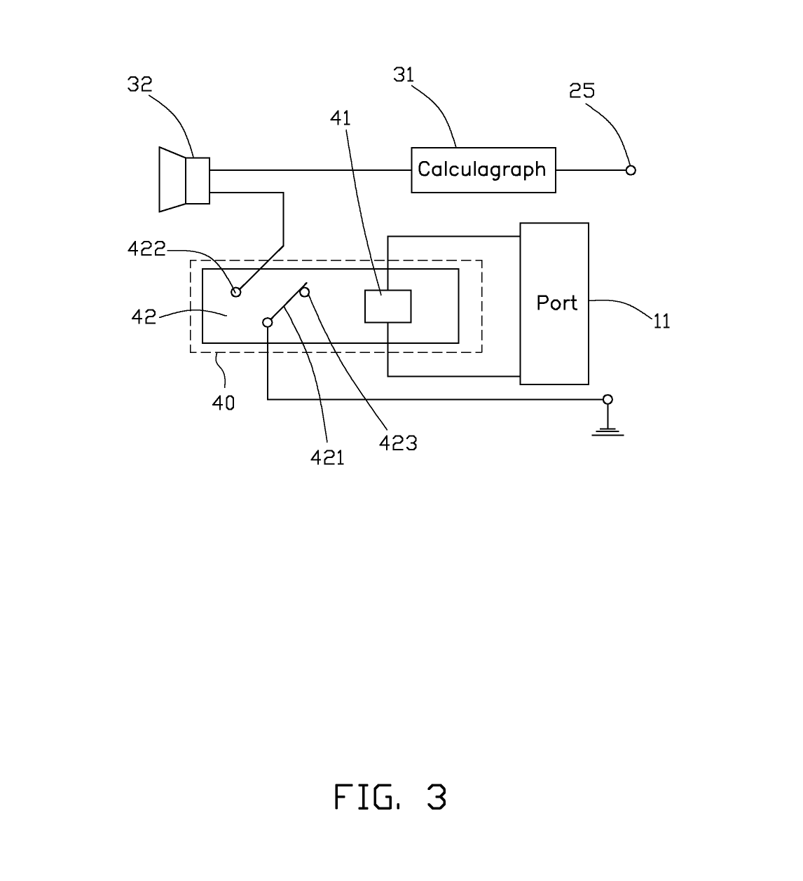

FIG. 3 shows that the alarming unit 30 includes a calculagraph 31 and a buzzer 32. The output end 25 is connected to the calculagraph 31, the buzzer 32, and the switch unit 40 in series. The switch 40 unit includes a relay 41 and a switch 42. The relay 41 is connected to the port 11. The switch 42 includes a conducting lever 421, a first conducting terminal 422 and a second conducting terminal 423. The conducting lever 421 is connected to ground. The first conducting terminal 422 is connected to the buzzer 32. The second conducting terminal 423 is suspended. The conducting lever 421 is pivotally mounted in the switch unit 40 and can rotate to alternatively connect the first conducting terminal 422 or the second conducting terminal 423. When the relay 41 is turned on, the conducting lever 421 is connected to second conducing point 423. When the relay 42 is turned off, the conducting lever 421 is connected to the first conducting terminal 422.

When there is a normal power provided to the controlling system 10, the port 11 outputs the high-level voltage signal to turn on the relay 41. The conducting lever 421 is connected to second conducing point 423. The alarming unit 30 is off and not works. When there is not a normal power provided to the controlling system 10, the port 11 does not outputs the high-level voltage signal to turn off the relay 41. The conducting lever 421 is connected to the first conducting terminal 422. The alarming unit 30 is turned on and works. The buzzer 32 sounds an alarm, and the calculagraph 31 starts to time a duration of the controlling system 10 being out of work.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A power supply detecting circuit for detecting a power supply status of a controlling system of a vending machine, comprising:
a port equipped on the controlling system, the port configured to output a high level voltage signal when a normal power is supplied to the controlling system;
a power supply unit;
an alarming unit connected to the power supply unit, the power supply unit providing power to the alarming unit; and
a switch unit connected between the alarming unit and ground, the switch unit controlled by the port, wherein the switch unit is configured to be turned off to switch off the alarming unit when the high level voltage signal is outputted from the port, and the switch unit is configured to be turned on to switch on the alarming unit when the normal power is not supplied to controlling system and the high level voltage signal is not outputted from the port.

2. The power supply detecting circuit of claim 1, wherein the alarming circuit comprises a buzzer, and the buzzer is configured to sound an alarm when the alarming unit is switched on.

3. The power supply detecting circuit of claim 1, wherein the alarming circuit comprises a calculagraph, and the calculagraph is configured to start to time a duration time of the normal power being not supplied to controlling system.

4. The power supply detecting circuit of claim 1, wherein the switch unit comprises a relay and a switch, the relay is connected to the port, the switch comprises a conducting lever connected to ground, a first conducting terminal connected to the alarming unit, and a second conducting terminal suspended, the relay is configured to be turned on to connect the conducting lever to the second conducting terminal when the port outputs the high level voltage signal, and the relay is configured to be turned off to connect the conducting lever to the first conducting terminal when the port does not output the high level voltage signal.

5. The power supply detecting circuit of claim 1, wherein the power supply unit includes an input end, a bridge circuit and an output end, the input end is connected to an AC power source, the bridge circuit is configured to convert the AC power into a DC power which is outputted to the alarming unit via the output end.

6. The power supply detecting circuit of claim 5, wherein an iron core transformer is connected between the input end and the bridge circuit, and the iron core transformer drops the AC power.

7. The power supply detecting circuit of claim 5, wherein a converting and filtering circuit is connected between the bridge circuit and the output end, and converting and filtering circuit is configured to convert and filter the DC power.

8. A power supply detecting circuit for detecting a power supply status of a controlling system of a vending machine, comprising:
a port equipped on the controlling system;
a switch unit connected to the port and controlled by the port;
an alarming unit connected to ground via the switch unit;
wherein the switch unit is configured to switch on the alarming unit when a normal power is not supplied to the controlling system and port turns on the switch unit.

9. The power supply detecting circuit of claim 8, wherein the alarming circuit comprises a buzzer, and the buzzer is configured to sound an alarm when the alarming unit is switched on.

10. The power supply detecting circuit of claim 8, wherein the alarming circuit comprises a calculagraph, and the calculagraph is configured to start to time a duration time of the normal power being not supplied to controlling system.

11. The power supply detecting circuit of claim 8, wherein the switch unit comprises a relay and a switch, the relay is connected to the port, the switch comprises a conducting lever connected to ground, a first conducting terminal connected to the alarming unit, and a second conducting terminal suspended, the relay is configured to be turned on to connect the conducting lever to the second conducting terminal when the port turns off the switch, and the relay is configured to be turned off to connect the conducting lever to the first conducting terminal when the port turns on the switch.

12. The power supply detecting circuit of claim 8, further comprising a power supply unit providing power to the alarming unit.

13. The power supply detecting circuit of claim 12, wherein the power supply unit includes an input end, a bridge circuit and an output end, the input end is connected to an AC power, the bridge circuit is configured to convert the AC power into a DC power which is outputted to the alarming unit via the output end.

14. The power supply detecting circuit of claim 13, wherein an iron core transformer is connected between the input end and the bridge circuit, and the iron core transformer drops the AC power.

15. The power supply detecting circuit of claim 13, wherein a converting and filtering circuit is connected between the bridge circuit and the output end, and converting and filtering circuit is configured to converting and filtering the DC power.
